(19) United States
(12) Patent Application Publication
(10) Pub. No.: US 2003/0175001 A1
(43) Pub. Date: Sep. 18, 2003

(54) Variable fiber optic attenuator

(76) Inventors: Brian L. Lawrence, Clifton Park, NY (US); Kwok Pong Chan, Troy, NY (US); Andrew Shapiro, Schenectady, NY (US); Robert Tatar, Saratoga Springs, NY (US); Renato Friello, Schenectady, NY (US); Matthew Laurie, Cohoes, NY (US); Mark Menrrick, Albany, NY (US)

Correspondence Address: HESLIN ROTHENBERG FARLEY & MESITI PC, 5 COLUMBIA CIRCLE, ALBANY, NY, 12203, US

(21) Appl. No.: 10/100,694

(22) Filed: Mar. 18, 2002

(51) Int. Cl. G02B 6/26

(52) U.S. Cl. 385/140; 385/15

(57) ABSTRACT

An electronically variable fiber optic attenuator is disclosed for adjustably extracting optical energy from a single, side-polished fiber optic, and therefore attenuating the optical signal being transmitted through the fiber optic. In one aspect, material is removed from a portion of the fiber optic, thereby exposing a surface through which optical energy can be extracted. A slab of material is positioned over the exposed surface of the fiber optic with a liquid overlay disposed therebetween. An actuator applies a force to the slab of material to deform or bend the slab of material into and out of the evanescent field of the fiber optic for extracting the optical energy.

### CROSS-REFERENCE TO RELATED APPLICATIONS/PATENTS

This application contains subject matter which is related to the subject matter of the following applications and patents which are assigned to the same Assignee as this application. The below-listed applications and patents are hereby incorporated herein by reference in their entirety:

Ser. No. 09/811,913, filed on Mar. 19, 2001, entitled “VARIABLE OPTICAL ATTENUATOR EMPLOYING POLARIZATION MAINTAINING FIBER;”

Ser. No. 09/812,097, filed on Mar. 19, 2001, entitled “FIBER OPTIC POWER CONTROL SYSTEMS AND METHODS;”

Ser. No. 09/605,110, filed on Jun. 28, 2000, entitled “SINGLE CHANNEL ATTENUATORS;”

Ser. No. 09/539,469, filed on Mar. 30, 2000, entitled “CONTROLLABLE FIBER OTIC ATTENUATORS EMPLOYING TAPERED AND/OR ETCHED FIBER SECTIONS;”

Ser. No. 09/139,832, filed on Aug. 25, 1998, entitled “BLOCKLESS TECHNIQUES FOR SIMULTANEOUS POLISHING OF MULTIPLE FIBER OPTICS;” and

Ser. No. 09/026,755 filed Feb. 20, 1998, entitled “FIBER OPTIC ATTENUATORS AND ATTENUATION SYSTEMS,”now U.S. Pat. No. 5,966,493 issued Oct. 12, 1999.

### FIELD OF INVENTION

The present invention relates to variable attenuators and attenuation systems for attenuating optical energy transmitted through a fiber optic.

### BACKGROUND OF INVENTION

As the Internet expands and bandwidth requirements increase, the demands placed on optical networks continue to grow. In particular, an ever expanding application set that includes new services like video-on-demand and high-speed data transmission as well as more traditional voice communications traffic pushes optical networks to continuously add functionality. The additional functionality results in a rapid increase in the complexity of these networks and requires a dynamic system which can be configured and re-configured as voice and data traffic patterns evolve. Many different components combine to provide functionality required in current and next generation networks. An adjustable attenuator, which is set at a desired level of attenuation and remains stable with time, temperature, etc. is an important part of this tailoring stage.

The majority of fiber optic adjustable attenuator devices commercially available rely on controlled air gaps between polished fibers. The attenuation level is adjusted by mechanically separating the fiber ends, and reducing the fraction of light captured by the pick-up fiber. Certain steps must be taken to provide acceptable levels of back-reflected light and avoid in-line etalon affects due to reflections from the polished fiber ends. Often this requires anti-reflection coatings or angle-polishing of the fiber ends that add to the cost and fabrication complexity of the device. Further, since these devices rely on mechanical parts, they are generally slow and possess shortcomings in long-term reliability.

Therefore, there is need for a variable fiber optic attenuator device that combines speed with optimum optical performance.

### SUMMARY OF THE INVENTION

The shortcomings of the prior approaches are overcome, and additional advantages are provided, by the present invention which in one aspect comprises an electronically variable fiber optic attenuator.

In one embodiment, the variable attenuator comprises an unbroken portion of a fiber optic through which optical energy is transmitted. The portion of the fiber optic has a side surface through which at least some of the optical energy is adjustably extracted. The attenuator further comprises a refractive index medium preform disposed over the side surface of the fiber optic, forming a gap therewith. A liquid overlay is disposed within the gap between the side surface and the medium preform. The liquid overlay maximizes the dynamic attenuation range while simultaneously minimizing polarization dependent losses and wavelength dependent losses. A means for locally displacing the medium preform within the gap between the medium preform and the side surface of the fiber optic to alter optical attenuation of the fiber optic is also provided.

In one aspect of the present invention, the means for locally displacing the medium preform comprises a piezoelectric translator.

Advantageously, by displacing a bulk material into and out of an evanescent field of a side-polished fiber optic using an electronically activated actuator, a faster response time with high-resolution control of attenuation is achieved. Also, by using a liquid overlay between the bulk material and the side-polished fiber optic, greater dynamic range is achieved while, at the same time, wavelength dependent losses and polarization dependent losses are minimized.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the concluding portion of the specification. The invention, however, both as to organization and method of practice, together with further objects and advantages thereof, may best be understood by reference to the following detailed description of the preferred embodiments (s) and the accompanying drawings in which:

FIG. 1 depicts a schematic representation of one embodiment of a variable fiber optic attenuator, in accordance with an aspect of the present invention;

FIG. 2 depicts a schematic representation of the variable fiber optic attenuator depicted in FIG. 1 illustrating displacement of an overlayed slab caused by a force applied by an actuator, in accordance with an aspect of the present invention;

FIG. 3 depicts a graphical representation of side-polished fiber transfer functions for various coupling strength fibers, in accordance with an aspect of the present invention;

FIG. 4 depicts a graphical representation of attenuation change derived from coupling strength changes using a fixed index overlay material, in accordance with an aspect of the present invention; and

FIG. 5 depicts a schematic representation of an electronically variable fiber optic attenuator, in accordance with an aspect of the present invention.

### DETAILED DESCRIPTION OF EMBODIMENTS OF THE INVENTION

Generally stated, provided herein is a variable attenuator operating on the coupling characteristics of a side-polished fiber platform. Optical energy is extracted from the fiber's core by application of a controllable bulk material and a layer comprising a liquid (e.g. oil or polymer) applied in a gap defined between the bulk material and the polished surface of the fiber. Attenuation is achieved by applying a force to displace (e.g. deform or bend) a slab of bulk material towards the exposed, evanescent surface of the side-polished fiber. The displacement of the bulk material reduces the gap between the bulk material and the fiber. For rapid attenuation response time, the attenuator may be electronically controlled using a piezoelectric translator, or other electronically controlled actuators, to displace the slab of bulk material.

Standard single-mode fibers have, for example, a 8.3 μm diameter core region of slightly raised refractive index surrounded by a 125±1 μm fused silica cladding. The mode field diameter is 9.3±0.5 μm at 1310 nm and 10.5±0.5 μm at 1550 nm. The refractive index values supplied by Corning for SMF-28 fiber are:

λ=1300 nm: ncore=1.4541, nclad=1.4484

λ=1550 nm: ncore=1.4505, nclad=1.4447

The small difference between the core and cladding refractive indices combined with the small core size results in single-mode propagation of optical energy with wavelengths above 1190 nm. Therefore, the fiber can be used in both spectral regions although it was designed for 1310 nm operation where dispersion (combination of material and waveguide dispersion) is minimized and attenuation is low (less than 0.4 dB/km).

There are numerous technologies which have been used to produce attenuation in fiber-optic systems. The early devices were based on splitting the optical fiber and separating the two ends. As the distance between the ends increased, so did the attenuation. A related technique was also used in which two fibers were separated by a fixed distance and collimating lenses were placed on each. A graded reflection or absorption filter was then slid between the two fiber ends. Both of these devices used stepper motors as the actuators.

Later devices used micro-electo-mechanical (MEM) technology in a variety of configurations. In some cases, the MEMs devices replaced the stepper motor with micromotors to provide the actuation. In other configurations, MEMs technology was used to produce deformable gratings. Still other attenuators were based on thermo-optic effects where a temperature change was used to produce a change in the refractive index of the waveguide material. This index change was then used in interferometric or coupling-based geometries to produce a corresponding attenuation.

All of these devices have certain drawbacks. The stepper motor based devices rely on moving parts which have shortcomings in long-term reliability and are generally slow relative to alternative technologies. MEMs devices can be very fast and more reliable than stepper motor devices, but often the depth of attenuation is low and ultra-low insertion loss and minimum back-reflection are difficult to achieve. Finally, thermo-optic devices are inherently slower but can still be fast enough to be useful. However, because these devices are often based on temperature changes in optical polymers, they can have other problems such as optical power dependent attenuation that may require some form of optical feedback.

Electronically variable fiber-optic attenuators (EVOAs) are used throughout optical networks to provide reconfigurable control of optical power levels. Specific applications for EVOAs in optical networks include trimming of power levels generated by transmitters, level control at receivers, power control of independent wavelengths at add/drop nodes, and power control within multi-stage optical amplifiers. Transmitter power control is necessary in multi-wavelength systems to ensure uniform power across the different wavelengths. At receivers, EVOAs are used to maintain the incident optical power within the range of optimum operation for the device. Throughout these dynamic networks the ability to add and drop channels is critical, and the ability to control power levels both going into and coming out of the system is similarly important. Finally, EVOAs also play a significant role in enabling the dynamic control of power levels between the stages of an optical amplifier. This results in optimum operation of the amplifier in both output power, output gain flatness, and gain tilt.

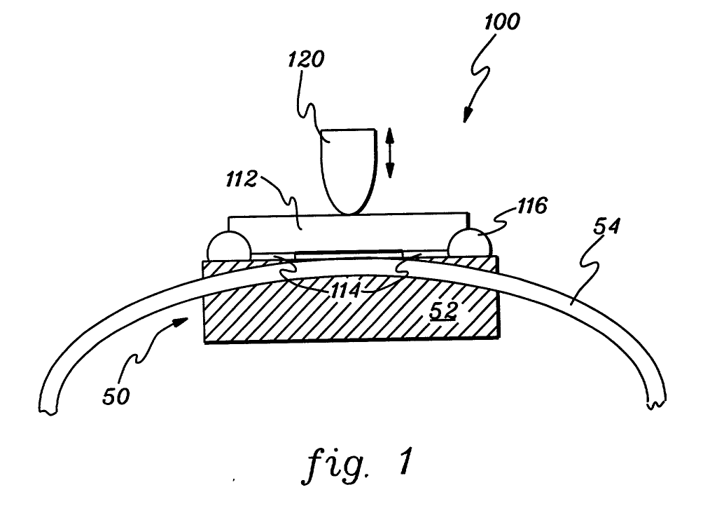

FIG. 1 depicts one embodiment of an attenuator, generally denoted 100, for attenuating optical energy transmitting in a fiber optic. Attenuator 100 includes a side-polished fiber assembly 50 comprising a fiber optic 54 and a block 52 for holding fiber optic 54 in a controlled radius groove in order to expose its polished core on a side portion. Attenuator 100 further includes a bulk material 112 disposed over the side portion of polished fiber 54 and an actuator 120 centrally positioned over bulk material 112.

Side-polished fiber assembly 50 may be fabricated by lapping and polishing techniques. Fiber 54 is embedded or epoxied in a fused silica substrate block 52 (e.g. 5×5×30 mm³) containing a controlled radius groove. Material is carefully stripped from the fiber cladding until the core is approached. At this point, the evanescent field of the optical energy transmitted in the optical fiber can be accessed through the surface. The device interaction length can be controlled by the remaining cladding thickness and the groove's radius of curvature. The polishing process continues until a predetermined amount of light is coupled out of the fiber when, for example, a liquid overlay, such as, for example, a polymer or an oil with an index (n_{d} at the sodium D line) of 1.6 or greater is applied.

Once the fiber core has been approached via the polishing process, a multiple liquid-drop procedure can be performed to characterize the side-polished fiber in terms of its refractive index response, e.g., as disclosed in Digonnet, M. J. F., Feth, J. R., Stokes, L. F., Measurement of the Core Proximity in Fiber Substrates and Couplers, Optics Letters, Vol. 10, No. 9, September 1985, the subject matter of which is incorporated herein by reference thereto.

This procedure involves placing a series of liquids, e.g., oils, or polymer of known refractive indices onto the polished surface of the fiber. This procedure compares the optical transmission (attenuation) of the side polished fiber with (i) air superstrate and (ii) known refractive index liquid superstrate. In the presence of an air superstrate, zero attenuation occurs. The transmission (attenuation) properties of a side polished fiber are dependent upon the penetration (the remaining cladding thickness) of the fiber evanescent field into whichever material is placed on the side polished fiber surface and also on the radius of curvature of the fiber. The presence of the liquid causes optical power to be coupled out of the side polished fiber and lost. Thus, the side polished fiber transmission is attenuated.

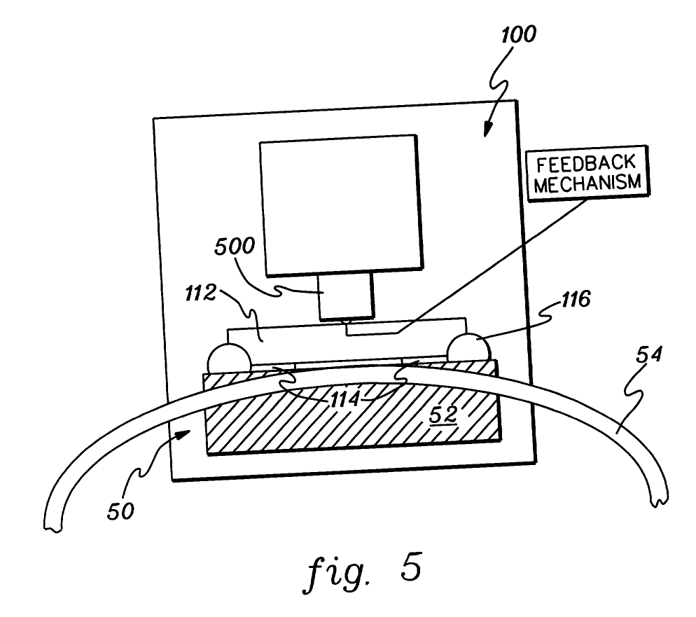

Bulk material 112 is mounted to block 52 directly over polished fiber 54. Bulk material 112 comprises a slab of material (e.g. 0.5×1×20 mm³) which aligns with the axis of polished fiber 54. Spacers or shims 114 of predetermined thickness (e.g. 12.5 μm) may be used to create a gap between polished fiber 54 and the bottom surface of bulk material 112. Alternatively, the top surface of block 52 may include supports projecting upwardly from or deposited on block 52 for supporting slab of bulk material 112 and for creating the gap between fiber 54 and bulk material 112. Once aligned, bulk material 112 is bonded in place using, for example, a thermally cured adhesive 116 such as, for example, model number BAF113 which is commercially available from Tracon of Indianapolis, Ind. The entire attenuation system 100 may be mounted to a plate 550 (see FIG. 5) using a thermally cured adhesive or a ceramic adhesive such as commercially available from Aremco of Valley Cottage, N.Y.

Bulk material 112 comprises, for example, a glass having an index of refraction closely matching the effective mode index of the fiber. Although, other materials, such as, for example, polymers may be used. Bulk material 112 should exhibit a stable index of refraction over a changing temperature, and stability after application of a central load. One suitable bulk material 112 would be Schott Borofloat, which is commercially available from Bes Optics, Inc. of W. Warwick, R.I.

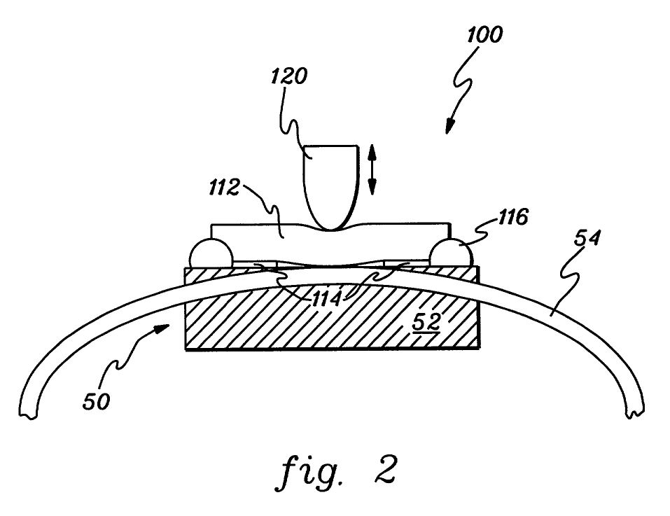

The gap defined between polished fiber 54 and bulk material 112 is decreased by activating actuator 120. Actuator 120 is aligned over the center of the slab of bulk material 112 to provide a force against the top surface thereof. As shown in FIG. 2, the applied force from actuator 120 locally displaces material 112 by, for example, deforming or bending the center portion of bulk material 112 towards the polished portion of fiber 54 so that a portion of slab 112 enters and exits the exposed, evanescent field of side-polished fiber 54 to effect an adjustable level of attenuation.

In one embodiment as depicted in FIG. 5, actuator 120 may be a translator. One example of a suitable translator is a piezoelectric translator 500 (e.g. model number AE5080D08 commercially available from Tokin America Inc. of Union City, Calif.) which directly converts electrical energy (voltage) into motion (mechanical energy) by expanding a piezoelectric stack (e.g. of 6 mm of crystal layers). The stack expands as a voltage is applied thereto. As the stack expands, pressure or force is applied to the slab of bulk material 112, moving a portion of slab 112 into the evanescent field of side-polished fiber 54. By attaching the slab of bulk material to the block rather than the stack of piezoelectric translator, the complexity of manufacturing the attenuator is substantially reduced. By using a piezoelectric translator, the actuation is not dependent on a mechanical device. Also, a piezoelectric translator offers high-speed variation while providing optimum optical performance.

Alternatively, actuator 120 may be an electrostatic device such as, for example, a capacitor, or an electro-strictive device (using a different material than used in a piezoelectric stack) or a plunger or other purely mechanical device. Movement of a mechanical device may be accomplished by, for example, a mechanical lever, micrometer adjustment, solenoid actuation or the like.

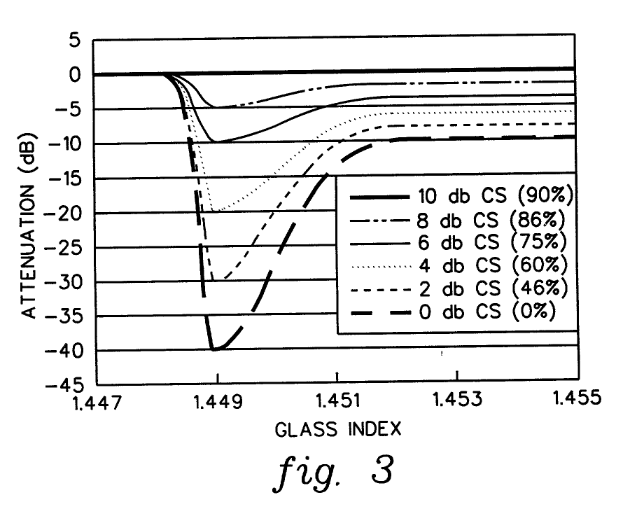

An attenuator made in accordance with an aspect of the present invention operates based on the fundamental coupling characteristics of a side-polished fiber platform. For example, for a fixed coupling strength polished fiber, the amount of light coupled out varies with the refractive index of the overlay material 112. This variation is often referred to as the transfer function. FIG. 3 depicts the shape of the transfer function for various coupling strength fibers. The curves in FIG. 3 also show that for a fixed refractive index, the attenuation varies with coupling strength. In one embodiment, the actuator is mounted into a housing and laser welded in place such that at 0 volts, no attenuation is observed and at 100 volts, at least 25 dB of attenuation is produced.

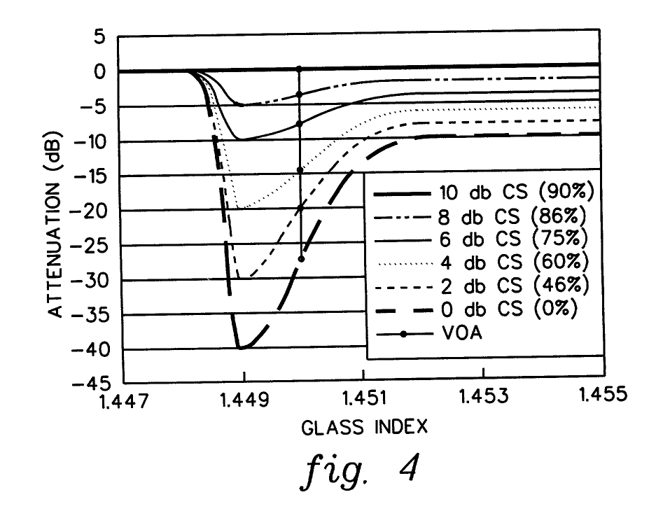

The coupling strength is varied by decreasing or increasing the gap distance between bulk material 112 and polished fiber 54 (e.g., a range of approximately 6 μm). For example, FIG. 4 shows that the attenuation range achievable for a refractive index of 1.45 spans from 0 dB to greater than 28 dB. By using a translator, such as a piezoelectric transducer, the actuator can have a response time of less than 1 ms. Also, by filling the gap between fiber 54 and bulk material 112 with a liquid, e.g. an oil or polymer, of specific refractive indices, a greater dynamic attenuation range is achieved while, at the same time, polarization dependent losses and wavelength dependent losses are minimized. Furthermore, by reducing the radius of curvature of the fiber in the block, the wavelength dependent losses can be further minimized.

In alternate embodiments, a feedback mechanism may be employed to measure strain on the actuator or gauge the strain on bulk material. For example, a strain gauge may be attached to the piezoelectric stack of a piezoelectric translator. One suitable strain gauge is a pre-wired strain gauge commercially available as model number KFG-3-350-C1-11L1M2R from Omega Engineering of Stanford, Conn. Also, a gauge may be provided to measure the capacitance between the block and the slab of bulk material. From the present description, it will be appreciated by those skilled in the art that the attenuator can be remotely controlled and/or other suitable sensors may be operably connected for automatically adjusting or monitoring the position, performance and operation of the attenuator and/or slab of bulk material.

In summary, the present invention relates to a variable attenuator employing an actuator to move a bulk material into and out of the exposed evanescent field to effect an adjustable level of attenuation. Adjustable attenuation is achieved by applying a force to the center of a slab of bulk material so that a portion of the slab displaces into the exposed, evanescent field of a side-polished fiber. For high-speed response, the force may be created by electronically stimulating a piezoelectric translator disposed over the slab of bulk material 112. An attenuator made in accordance with an aspect of the present invention provides high-resolution control of the attenuation with a large dynamic range and a full-scale response time of less than 1 ms.

An electronically variable optical attenuator in accordance with the present invention is intended for use in fiber-optic communication systems. The system is used to reduce the power of the optical signal traveling in an optical fiber by a variable yet controllable amount. This has specific application in areas where too much optical power can saturate a later device such as an optical amplifier or receiver. In addition, the system responds to a control voltage, which means that the attenuation level is dynamically adjustable. This is significant in optical networks where reconfiguring the network to accommodate changing traffic patterns is important. Using an attenuator with optical properties determined by a controlled voltage offers the potential to reconfigure the network remotely from a central control point.

While the invention has been described in detail herein accordance with certain preferred embodiments thereof, many modifications and changes therein may be effected by those skilled in the art. Accordingly, it is intended by the appended claims to cover all such modifications and changes as fall within the true spirit and scope of the invention.

What is claimed is:

1. An attenuator for attenuating optical energy, said attenuator comprising:
an unbroken portion of a fiber optic through which optical energy is transmitted, said portion having a side surface through which at least some of the optical energy is adjustably extracted;
a refractive index medium preform disposed over the side surface of the fiber optic, said medium preform and the side surface of the fiber optic defining a gap therebetween;
a liquid overlay, said liquid overly disposed within the gap formed between said side surface and said medium preform; and
means for locally displacing said medium preform towards the side surface of said fiber optic to alter optical attenuation of the fiber optic.

2. The attenuator of claim 1, wherein said means for locally displacing said medium preform is a piezoelectric translator.

3. The attenuator of claim 1, wherein said liquid overlay is an oil.

4. The attenuator of claim 1, wherein said liquid overlay is a polymer.

5. The attenuator of claim 1, wherein said preform adjustably extracts optical energy in response to an electrical charge applied to said displacing means.

6. The attenuator of claim 1, wherein the side surface comprises a length and a width, said preform extending across the length of the side surface.

7. The attenuator of claim 1, wherein said preform comprises a slab of bulk material.

8. The attenuator of claim 1, further comprising a feedback mechanism to measure strain on said actuator.

9. The attenuator of claim 8, wherein the feedback mechanism is a strain gauge.

10. The attenuator of claim 1, further comprising a feedback mechanism to measure strain on said slab of bulk material.

11. The attenuator of claim 1, further comprising a capacitor position sensor for measuring the capacitance between a block holding the fiber optic and said slab of bulk material.

12. An attenuator for attenuating optical energy, said attenuator comprising:
an unbroken portion of a fiber optic through which the optical energy is transmitted, said portion having a side surface through which at least some of the optical energy is adjustably extracted;
a flexible slab of material mounted above the side surface of said fiber optic, said slab of material and the side surface of said fiber optic defining a gap therebetween;
a liquid overlay for minimizing polarization dependent losses, said liquid overlay disposed within the gap defined between the side surface and said medium preform; and
an actuator disposed above said flexible slab of material, said actuator configured to displace a portion of said flexible slab of material into and out of an exposed evanescent field of said fiber optic to adjustably extract optical energy from the fiber optic.

13. A controllable attenuator for attenuating optical energy transmitted through a fiber optic, said controllable attenuator arranged with respect to a portion of the fiber optic, the portion of the fiber optic having material removed thereform thereby exposing a side surface thereof through which at least some of said optical energy transmitted therein can be extracted, the portion of fiber optic embedded in a block, said controllable attenuator comprising:
a flexible slab of material having ends, said ends of the flexible slab of material mounted on the block, a center portion of said slab of material arranged above the side surface of said fiber optic, said slab of material and the side surface of said fiber optic defining a gap therebetween;
a liquid overlay for minimizing polarization dependent losses, said liquid overlay disposed within the gap defined between the side surface and said medium preform; and
an actuator disposed above the center portion of said flexible slab of material, said actuator configured to displace the center portion of said flexible slab of material towards the side surface to adjustably extract optical energy from the fiber optic.

14. A method for attenuating optical energy transmitted in a fiber optic, said method comprising:
providing an unbroken portion of the fiber optic through which the optical energy is transmitted, having a side surface through which at least some of the optical energy is adjustably extracted;
providing a liquid overlay for minimizing polarization dependent losses directly over the side surface; and
displacing a slab of bulk material into and out of an exposed evanescent field of said fiber optic to adjustably extract optical energy from the fiber optic.

15. A method for fabricating an attenuator for attenuating optical energy, said method comprising:
providing a fiber optic having a side surface;
positioning a slab of bulk material over the side surface through which at least some of the optical energy is adjustably extracted;
disposing a liquid overlay in a gap defined by the side surface and the slab of bulk material;
positioning an actuator over the slab of bulk material, said actuator configured to displace a portion of the slab of bulk material towards the side surface to alter optical attenuation of the fiber optic.
